(19) United States
(12) Patent Application Publication
(10) Pub. No.: US 2008/0080200 A1
(43) Pub. Date: Apr. 3, 2008

(54) Lighting systems using light active sheet material with integrated leadframe, and methods for manufacturing the same

(75) Inventors: Stanley D. Robbins, Deputy, IN (US); William Dominic Grote, Madison, IN (US); Timothy W. Brooks, Madison, IN (US); Richard C. Bozich, Canton, MI (US)

Correspondence Address: POSZ LAW GROUP, PLC, 12040 SOUTH LAKES DRIVE, SUITE 101, RESTON, VA, 20191, US

(73) Assignee: Grote Industries, Inc, Madison, IN (US)

(21) Appl. No.: 11/902,980

(22) Filed: Sep. 27, 2007

Related U.S. Application Data
(60) Provisional application No. 60/847,935, filed on Sep. 29, 2006.
(60) Provisional application No. 60/847,917, filed on Sep. 29, 2006.

(51) Int. Cl. B60Q 1/26; H01J 9/24

(52) U.S. Cl. 362/487; 445/23

(57) ABSTRACT

A lighting system includes a leadframe, and a light active sheet material laminated on the leadframe and electrically connected to the leadframe. The light active sheet material includes a transparent electrically conductive top substrate, a pattern of one or more light emitting diode (LED) chip(s) sandwiched between the leadframe and the top substrate, and a non-conductive transparent adhesive material disposed between the leadframe, the LED chip(s), and the top substrate. The LED chip(s) is (are) preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the leadframe.

### CROSS-REFERENCE TO RELATED APPLICATIONS

This application claims the benefit of U.S. Provisional Application No. 60/847,935 filed Sep. 29, 2006; and U.S. Provisional Application No. 60/847,917 filed Sep. 29, 2006, both of which are expressly incorporated herein by reference.

### TECHNICAL FIELD

The technical field relates in general to light sources, and more specifically to various light active sheet material with an integrated lead frame.

### BACKGROUND

In the vehicle lighting industry, illumination can be achieved through the use of various light sources, all of which require complex manufacturing processes or complex methods of excitation.

For example, an incandescent bulb consists of a filament light source packaged inside a glass bulb. The bulb must be evacuated of air and filled with a gas. The entire envelope must be sealed. These types of light sources typically fail after a short life due to filament breakage. Furthermore, since the light source is formed from glass, the handling and mounting of the light source is a delicate procedure and breakage is common.

Similarly, gas discharge lamps, such as high intensity discharge and fluorescent, may contain undesirable materials such as mercury. As with incandescent bulbs, a glass envelope must be formed, evacuated, filled and sealed, leading to a high processing cost. These types of lamps typically require complex electronics to excite the gases in order to extract light from the tube. In addition, because the light source is formed from glass, the handling and mounting of the light source is delicate and breakage is common. Thus, to create a finished, useable lamp, the light source must be carefully packaged and the electronics designed to have proper operation in its intended environment, such as on a vehicle.

Electroluminescent lighting, on the other hand, typically lends itself to simple processing methods. However, it requires a high voltage at a frequency that can interfere with other electrical components through electromagnetic interference.

Light emitting diodes (LEDs), such as illustrated in FIG. 20, typically require a die bond, a wire bond and a molding operation to create an LED component. This part can then be manufactured into a printed circuit board with additional components to protect and bias the LED. A finished lamp may then use a lens and a body to direct the light and support the circuit board, respectively.

Federal regulations require that large vehicles have a side marker lamp mounted on the side of the top rear corner of the vehicle. The regulations also require a clearance lamp mounted on the rear of the top rear corner of the vehicle. One allowed modification of these requirements is to mount a lamp at a 45° angle directly onto the corner of the vehicle. If this lamp has a wide enough light pattern to meet the requirements of both of the other required lamps, one lamp can replace two. Such lamps are called “PC” lamps after the Society of Automotive Engineers' (SAE) marking requirements for such lamps.

Although PC lamps can be a cost savings to the vehicle manufacturer, there are still some difficulties associated with their mounting. Often a bracket must be manufactured or the corner of the vehicle must be chamfered in order to provide a mounting surface for the lamps. PC lamp optics also are difficult to design because of the required wide emission pattern of the light. LED lamps especially have a difficult time meeting the PC specification because LEDs tend to emit light in a narrow conical beam. Great effort must be put into the optics designs of LED lamps to enable them to meet the PC requirements. The lamps typically are plastic lamps with a flat base, which must be mounted on a bracket in order to fit on the corner of a vehicle. However, the vehicle must be modified to provide a flat mounting area at a 45° angle to allow mounting of the PC lamp.

Current trailer lighting systems use discrete wires and lights along the top rails of the trailer to meet federal regulations regarding marker lamps. Furthermore, there is a connection interface between the light and the harness, which adds cost and allows an entry point for water.

Conventional accent lighting uses incandescent lamps. These lamps require large battery packs or frequent battery replacement for continuous use over several hours, for example, 7-8 hours. Fluorescent lamps would be more power efficient, but they would be too bulky and too fragile for rugged applications. LED lamps are more power efficient and more rugged, but they require mounting substrates that make them not only bulky, because circuit boards must be packed in some type of housing and a lens is required, but also expensive, because flexible circuit boards or metal core circuit boards are expensive.

Bulky incandescent lamps can be used for illumination. They can be attached, for example, to a seat at the end of the aisle and aimed at a floor or attached to a wall or underside of a rail. They can also be recessed into the seat, wall, sidewalk, side of a step, or the like. Sidewalk mounting requires having the lamp protrude up from the sidewalk, which can be unsafe, or recessing the lamps by creating a space beforehand (which requires advance planning), or creating a hole into which the lamp can be recessed (which can be expensive). Conventional LED lamps can be used similarly, except that the LED lamps are smaller.

A strip of conventional LEDs can also be used in accent lighting. These can be secured on the edge of walkways, along a wall, on rails, or on the edge of steps. They can also be used on the side of a seat at the end of the aisle (for example, facing down on the underside of an armrest, or with a shield to block unwanted light). These strips are typically expensive.

### SUMMARY

Accordingly, one or more embodiments provide a lighting system, and methods for using/manufacturing a lighting system. The lighting system includes a leadframe, and a light active sheet material laminated on the leadframe and electrically connected to the leadframe. The light active sheet material includes a transparent electrically conductive top substrate, a pattern of one or more light emitting diode (LED) chip(s) sandwiched between the leadframe and the top substrate, and a non-conductive transparent adhesive material disposed between the leadframe, the LED chip(s), and the top substrate. The LED chip(s) is (are) preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the leadframe.

A method of manufacturing a lighting system includes providing a leadframe. The leadframe includes leads and light emitting diode (LED) chip placement portions. A pattern of LED chips is placed on an LED chip placement portion of the leadframe. An adhesive is disposed on the leadframe and the LED chips, the adhesive being formed of a non-conductive transparent adhesive material. After disposing the adhesive, a transparent electrically conductive top substrate is laminated on the adhesive and the LED chips. The LED chips are preformed before being patterned as an unpackaged discrete semiconductor device having an anode p-junction side and a cathode n-junction side. Either of the anode and the cathode side is in electrical communication with the top substrate and the other of the anode and the cathode side is in electrical communication with the leadframe.

One or more embodiments concern a device and/or a method of providing a conveyance with a lighting system. A lighting system is provided, wherein the lighting system includes a leadframe, and a light active sheet material laminated on the leadframe and electrically connected to the leadframe. The light active sheet material includes a transparent electrically conductive top substrate, and a pattern of light emitting diode (LED) chips sandwiched between the leadframe and the top substrate. The LED chips are preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the leadframe. A non-conductive transparent adhesive material disposed between the leadframe, the LED chips, and the top substrate. The lighting system is mounted on the conveyance. The lighting system is electrically connected to an electrical wiring harness of the conveyance.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a cross sectional diagram illustrating a light sheet of a single light emitting diode (LED) on a leadframe;

FIG. 2 is a schematic diagram corresponding to FIG. 1;

FIG. 3 is a perspective view of LED chips on a leadframe prior to lamination;

FIG. 4 is a cross sectional diagram illustrating the LED chips on the leadframe of FIG. 3;

FIG. 5 is schematic diagram corresponding to FIG. 4;

FIG. 6 is a perspective view of LED chips on leadframe, biased opposite of each other prior to lamination;

FIG. 7 is a cross sectional diagram of the embodiment shown in FIG. 6 taken along line VII-VII, after lamination;

FIG. 8 is a cross sectional diagram of the embodiment shown in FIG. 6 taken along line VIII-VIII, after lamination;

FIG. 9 is a schematic diagram corresponding to FIG. 6;

FIG. 10A-10F are cross sectional diagrams illustrating a method of producing the light sheet on a leadframe;

FIG. 11 is a plan view illustrating a method of producing a light sheet on a leadframe;

FIG. 12 is a cross sectional diagram of the embodiment shown in FIG. 11 taken along line XII-XII;

FIG. 13 is a cross sectional diagram of the embodiment shown in FIG. 11 taken along line XIII-XIII;

FIG. 14 is a perspective exploded view of a lamp using a light sheet on a leadframe;

FIG. 15 is a cross sectional diagram of a lens with conical optics for a lamp using a light sheet;

FIG. 16 illustrates a lamp with conical optics using a light sheet on a leadframe;

FIG. 17 is a perspective view of a cone for a lens with conical optics;

FIG. 18 is a top view of the cone for the lens with conical optics;

FIG. 19 is a top view of a faceted optic for a lens with conical optics;

FIG. 20 is a perspective cross sectional diagram of a prior art single packaged LED;

FIG. 21 is a plan view of a light sheet on a leadframe mounted on trailer corner;

FIG. 22 is a cross sectional view of a light sheet on a leadframe attached to radii lamp base;

FIG. 23 is a plan view of a marker lamp integrated with a leadframe;

FIG. 24 is a perspective view of the marker lamp of FIG. 23 mounted on a trailer;

FIG. 25 is a side view of a first watercraft illuminated with a light sheet leadframe tape;

FIG. 26 is a side view of a second watercraft illuminated with the light sheet leadframe tape;

FIG. 27 is a side view of a barge illuminated with the light sheet leadframe tape;

FIG. 28 is a rear view of a watercraft illuminated with the light sheet leadframe tape;

FIG. 29 is a rear view of the watercraft illuminated with an alternative configuration of the light sheet leadframe tape;

FIG. 30 is a perspective view of a lawn mower with a surface mounted light sheet leadframe lamp;

FIG. 31 is a perspective view of a light sheet leadframe package mounted on a printed circuit board (PCB); and

FIG. 32 is a cross sectional diagram illustrating LED chips on a leadframe, connected in parallel.

### DETAILED DESCRIPTION

In overview, the present disclosure concerns a light active sheet material, where light emitting diode (LED) chips and leadframes are integrated in the light active sheet material, and optionally lamps and/or lighting systems incorporate the light active sheet material. The light active sheet material, sometimes referred to as “light sheet,” can reduce the profile of the lamps and/or lighting systems because the light sheet with integrated LEDs can be flat and thin. Moreover, a light sheet does not require housings or hard lenses than can be damaged or cracked. The thin characteristic of the light sheet can be exploited to provide illuminated devices in various forms for accent, safety, or cosmetic purposes, including without limitation flat lighting on surfaces, and/or lighting bent to conform to the shapes of surfaces. Examples of lamps and/or lighting systems include interior illumination and exterior illumination, for example for conveyances, including for example marker lamps, dome lamps, high mount stop lamps (HMSL), center high mount stop lamps (CHMSL), stop/tail/turn (STT) lights, front/park/turn (FPT) lights, fog lamps, headlamps, and the like. More particularly, various inventive concepts and principles are embodied in systems, devices, and methods therein relating to LED chips and leadframes integrated in a light active sheet material.

The conveyances of particular interest include automobiles, trucks, motorized vehicles, trains, trailers, aircraft, watercraft, heavy machinery used for regulated or non-regulated industries such as agricultural, lawn care, mining, snow blowing, and the like, and variants or evolutions thereof.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

As further discussed herein below, various inventive principles and combinations thereof are advantageously employed to reduce the cost of manufacture and application of lighting elements. Light active sheet material with integrated leadframe can provide a simple process of manufacturing. Furthermore, the integrated leadframe and other materials integral to the light active sheet material provide intrinsic circuit elements which can be utilized for proper biasing of the LED chips.

Further in accordance with exemplary embodiments, a light active sheet material can utilize a leadframe commonly used in semiconductor manufacturing. The LED chip can be secured to the leadframe in accordance with techniques used in semiconductor manufacturing. After the LED chip is secured to the leadframe, the electrical connection between the LED chips can be facilitated, for example, through a lamination process.

A top transparent conductor material with a resistive characteristic can be used in the light active sheet material. Placement of the LED chips can be specified such that a set, known resistance is in series with the LED chips. This resistance allows a designer to set the current through the LED chips, for example providing a replacement to the discrete resistor now typically soldered into a printed circuit board (PCB) in connection with conventional LED lamps. For example, two LED chips can be placed so that a function is flipped, one from another, thereby providing two LED chips in series with the transparent conductor resistor between them.

LED chips have a characteristic of clamping the forward voltage to approximately 2 to 4 volts, depending on the material of the LED. LED chips can also handle a reverse voltage of 5 volts or less. Using these characteristics, one LED chip can protect another from the detrimental effect of reverse voltage.

A combination of the transparent conductor resistance and two parallel LED chips placed with opposite polarity can provide an effective bias and protection, all processed in a continuous cell process.

The use of light active sheet material can provide an integrated LED lamp within a footprint of a typical semiconductor component. The thin profile of the leadframe can permit a flexible assembly which can be formed to various surfaces. The ability to process leadframes as a continuous roll can allow a high volume, continuous production method.

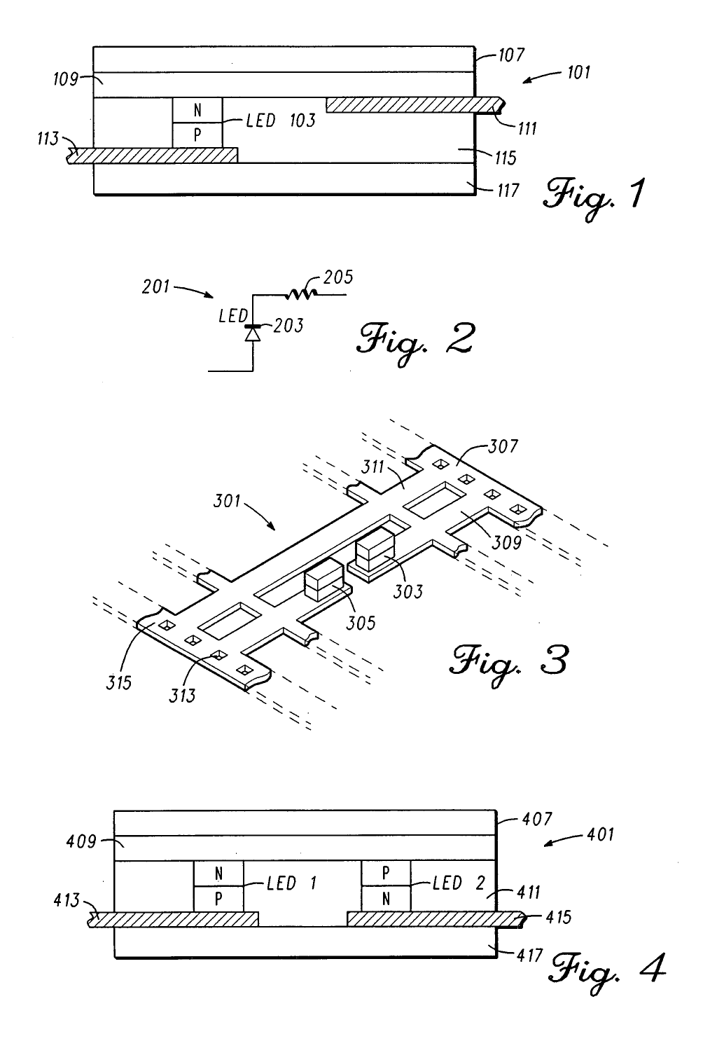

An LED chip can be utilized with a light active sheet material on a leadframe, as illustrated in the cross section of FIG. 1 and the corresponding schematic of FIG. 2.

Referring now to FIG. 1, a cross sectional diagram illustrating a light sheet of a single light emitting diode (LED) on a leadframe will be discussed and described. A light active sheet material 101 includes a transparent electrically conductive top substrate (for example the illustrated ITO layer) 109, a transparent substrate 107, an optional bottom substrate 117, a leadframe (including a first portion 113 and a second portion 111), one or more light emitting diode (LED) chips 103, and an adhesive 115. The “top” is used to indicate an area toward which light from the LEDs (such as LEDs 3, 4) will be emitted, and a “bottom” indicates the opposite side of the light sheet.

The transparent substrate 107 can be disposed as a top layer of the light sheet 101. Optionally, the transparent substrate 107 can be omitted. Accordingly, the transparent substrate 107 can be formed of a transparent or translucent material. The material of the optional transparent substrate 107 advantageously can be flexible. Appropriate materials for use as the transparent substrate 107 include transparent or translucent plastics, for example, polymers such as polyethylene terephthalate (PET) and polyethylene 2,6 naphthalene dicarboxylate (PEN), and variations and/or blends thereof.

The transparent electrically conductive top substrate 109 can be disposed onto the transparent substrate 107, prior to assembly of the light sheet. Electrically, the electrically conductive top substrate 109 is below the transparent substrate 107; the electrically conductive top substrate 109 is in electrical contact with the LED chip 103. As illustrated, the electrical contact between the transparent electrically conductive top substrate 109 and the LED chip 103 is direct. Furthermore, the transparent electrically conductive top substrate 109 is in direct electrical contact with the second portion 111 of the leadframe. Also, the light from the LED chip 103 will shine through the transparent electrically conductive top substrate 109. Accordingly, the transparent electrically conductive top substrate 109 can be formed of an electrically conductive material which is also optically transparent or translucent. An appropriate material is a conducting metal oxide, for example an indium tin oxide (ITO) film (as illustrated), a carbon nanotube conductive film, an aluminum-doped zinc oxide film, and/or a conductive polymer layer such as PEDOT:PSS (poly(3,4-ethylenedioxythiophene) poly(styrenesulfonate)) and/or PEDOT (poly(3,4-ethylenedioxythiophene)) available from, for example, Agfa or H.C. Starck.

The LED chip 103 has a p-side and an n-side and/or light-to-energy semiconductor layered particles, wherein the n-side and p-side correspond to charge donor and charge acceptor layers. One of the p-side or n-side of the LED chip 103 is in direct electrical contact with the electrically conductive top substrate 109, and therefore is in indirect electrical contact with the second portion 111 of the leadframe via the electrically conductive top substrate 109. The other p-side or n-side of the LED chip 103 is in direct electrical contact with the first portion 113 of the leadframe disposed below the LED chip 103. Appropriate LED chips are widely available commercially. The LED chip 103 can be connected to the first portion 113 of the leadframe via a die bond material (not illustrated), for example via a silver-filled epoxy or functional equivalents.

The leadframe (here represented by first and second portions 113, 111) is formed of a conductive material, for example, conductive metal which has been stamped or formed to an appropriate shape. The bottom substrate 117 can be formed of a flexible non-conductive material, for example, a polymer, FR-4 (Flame Resistant 4 (fiberglass-resin)), CEM-1 (Composite Epoxy Material 1 (fiberglass-cellulose-resin)); or any non-conductive material.

The adhesive 115 is disposed to fill gaps around the LED chip 103, gaps between the transparent electrically conductive top substrate 109 and the first portion 113 of the leadframe, and gaps between the second portion 111 of the leadframe and the bottom substrate 117. The adhesive 115 also mechanically holds the first top substrate 109, the first and second portions 111, 113 of the leadframe, and the bottom substrate 117 together. The adhesive 115 electrically isolates the first top substrate 109 from the leadframe 113, and therefore is formed of a non-conductive adhesive material. Furthermore, the adhesive is transparent.

The first portion 113 of the leadframe below the LED chip 103 is spaced apart from the second portion 111 of the leadframe. The first and second portions 111, 113 of the leadframe have opposite polarity. As will be described below in more detail, the first and second portions 111, 113 of the leadframe may be connected to a power source. In this configuration, a resistor is formed in the transparent electrically conductive top substrate 109 between the LED chip 103 and the second portion of the leadframe 111.

Additional LED chips can be added using the above principles, as will be appreciated by one of ordinary skill in the art.

Accordingly, a lighting system can include a leadframe, and a light active sheet material laminated on the leadframe and electrically connected to the leadframe wherein the light active sheet material comprises a transparent electrically conductive top substrate, a pattern of one or more light emitting diode (LED) chips sandwiched between the leadframe and the top substrate, and a non-conductive transparent adhesive material disposed between the leadframe, the LED chip(s), and the top substrate. The LED chip(s) is (are) preformed before being patterned in the light active sheet material as an unpackaged discrete semiconductor device having an anode p-junction side and a cathode n-junction side. Either of the anode and the cathode side is in electrical communication with the top substrate and the other of the anode and the cathode side is in electrical communication with the leadframe.

Further, the lighting system can include a bottom substrate disposed on the leadframe on a side opposite to the LED chip(s).

Referring now to FIG. 2, a schematic diagram corresponding to FIG. 1 will be discussed and described. A light sheet material 201 includes an LED chip 203 connected to a resistor 205. Referring back to FIG. 1, the resistor 205 is formed by the connection of the LED chip 103 on the one of the n-side or the p-side to the transparent electrically conductive top substrate 109 and the second portion 111 of the leadframe, and the other of the n-side or the p-side to the first portion 113 of the leadframe.

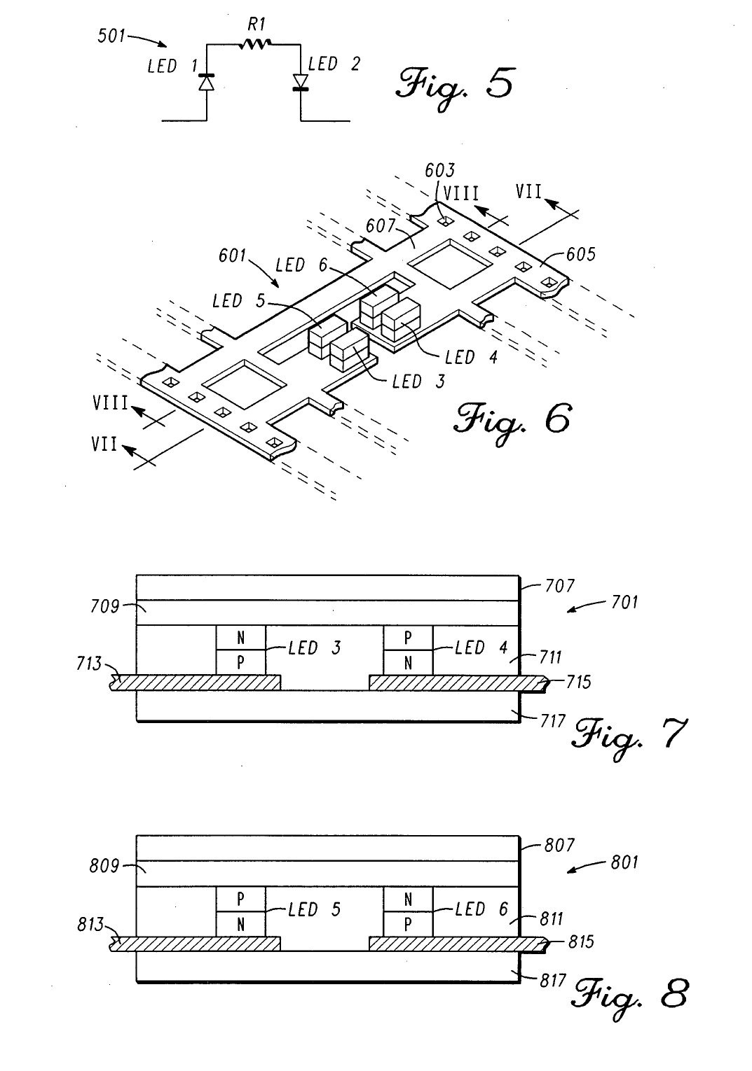

FIG. 3, FIG. 4, and FIG. 5 relate to LED chips disposed on a leadframe, in series, in a light active sheet material. FIG. 3 provides a view illustrating LED chips on the leadframe prior to lamination. FIG. 4 provides a cross-section of the layers of the light active sheet material on the leadframe; and FIG. 5 is a schematic corresponding to FIG. 4.

Referring now to FIG. 3, a perspective view of LED chips on a leadframe prior to lamination will be discussed and described. A representative leadframe 301 and LED chips 303, 305 are illustrated. The leadframe 301 includes tool hole edges 307, 315, track keepers (not visible), leads 309, 311, and LED chip placement portions (under the LED chips 303, 305) (also referred to as “die pads”). The tool hole edges 307, 315 can include tool holes 313 formed therein, which typically are intended for use in further manufacturing processes.

The leadframe 301 can be elongated, so that the track keepers (not visible) extend linearly parallel to an axis of the leadframe 301. In this illustration, the leads 309, 311 extend perpendicularly to the axis. The light active sheet material, when finished, will not include the tool hole edges 307, 315 or track keepers, which are utilized for ease of manufacturing. Optionally, the tool hole edges 307, 315 and track keepers can be omitted from the leadframe 301, and/or the leadframe can take other forms, for example, rectangular or square.

The LED chips 303, 305 can be patterned on the leadframe. The led chips 303, 305 can be mounted on the leadframe 301, for example in accordance with conventional techniques used for mounting semiconductor components on leadframes. LED chips having opposite polarity which are to be electrically connected laterally across the leadframe 301 form a set of LED chips. In this illustration, the set of LED chips includes LED chips 303, 305.

Accordingly, in a lighting system, the leadframe can have a linear form, there can be a plurality of sets of LED chips including the at least one LED chip, and each set of LED chips can include at least two LED chips biased opposite of each other and electrically connected laterally across the leadframe, wherein the sets of LED chips are distributed axially along the leadframe.

Referring now to FIG. 4, a cross sectional diagram illustrating the LED chips on the leadframe of FIG. 3 will be discussed and described. A light active sheet material 401 includes a transparent substrate 407, a transparent electrically conductive top substrate (here represented by ITO layer 409), an optional bottom substrate 417, a first portion 413 and a second portion 415 of a leadframe, light emitting diode (LED) chips (represented by LED chip 1 and LED chip 2), and adhesive 411.

The transparent substrate 407 is disposed as a top layer of the light sheet, and can be formed of a transparent or translucent material. Appropriate materials for use as the transparent top substrate 407 include those discussed in connection with FIG. 1.

The transparent electrically conductive top substrate 409 is disposed below the top substrate 407, if used. The transparent electrically conductive top substrate 409 is in electrical contact with the LED chips 1, 2. As illustrated, the electrical contact between the transparent electrically conductive top substrate 409 and the LED chips 1, 2 is direct. Also, the light from the LED chips 1, 2 will shine through the transparent electrically conductive top substrate 409. Appropriate materials for use as the transparent electrically conductive top substrate 409 include those discussed in connection with FIG. 1.

Each of the LED chips 1, 2 has a p-side and an n-side and/or light-to-energy semiconductor layered particles, wherein the n- and p-side correspond to charge donor and charge acceptor layers. The LED chips 1, 2 are oriented to be driven with opposite polarity electrical energy. The LED chips 1, 2 are in electrical contact with the transparent electrically conductive top substrate 409 as well as the first portion 413 or the second portion 415 of the leadframe disposed below respective LED chips 1, 2. The LED chips 1, 2 are respectively patterned on the first portion 413 and the second portion 415 of the leadframe, as further described below.

Appropriate materials for use as the leadframe (here represented by first and second portions 413, 415) and the bottom substrate 417 include those discussed in connection with FIG. 1.

The adhesive 411 is disposed to fill gaps between the adjacent patterned LED chips, gaps between the transparent electrically conductive top substrate 409 and the first portion 413 and the second portion 415 of the leadframe, gaps between the first portion 413 and the second portion 415 of the leadframe, and gaps between the transparent electrically conductive top substrate 409 and the optional bottom substrate 417 (if used). As with the adhesive discussed in connection with FIG. 1, the adhesive 411 can be formed of a non-conductive transparent adhesive material, and can serve to mechanically hold together the transparent electrically conductive top substrate 409, the first and second portions 413, 415 of the leadframe, the LED chips 1, 2, and the optional bottom substrate 417.

The first portion 413 and second portion 415 of the leadframe below the LED chips 1, 2 which are biased opposite of each other in series, are spaced apart from each other so that a gap is formed between the first portion 413 and the second portion 415 of the leadframe. The first portion 413 and the second portion 415 of the leadframe have opposite polarity. As will be described below in more detail, the leadframe may be connected to a power source. In the illustrated configuration, a resistor is formed in the transparent electrically conductive top substrate 409 between the two LED chips 1, 2.

Accordingly, a lighting system can include plural LED chips, including the above-discussed one or more LED chips, in the pattern of LED chips, and the LED chips in the pattern are electrically connected in series, wherein adjacent connected LED chips are biased opposite of each other.

Further accordingly, the lighting system can include plural LED chips, wherein a first portion of the leadframe below and in electrical communication with one of the LED chips is spaced apart from a second portion of the leadframe below and in electrical communication with the other of the LED chips which are electrically connected.

Although only two LED chips are illustrated, additional LED chips can be added and connected in series using the above principles, as will be appreciated by one of ordinary skill in the art.

Referring now to FIG. 5, schematic diagram corresponding to FIG. 4 will be discussed and described. The light active sheet material 501 on the leadframe includes LED chips 1, 2. The LED chips 1, 2 are biased opposite of each other and connected in series (via the transparent electrically conductive top substrate 409 discussed in connection with FIG. 4), through a resistor R1. In this configuration, the resistor R1 is formed between the LED chips 1, 2 by the resistive properties of the transparent electrically conductive top substrate 409.

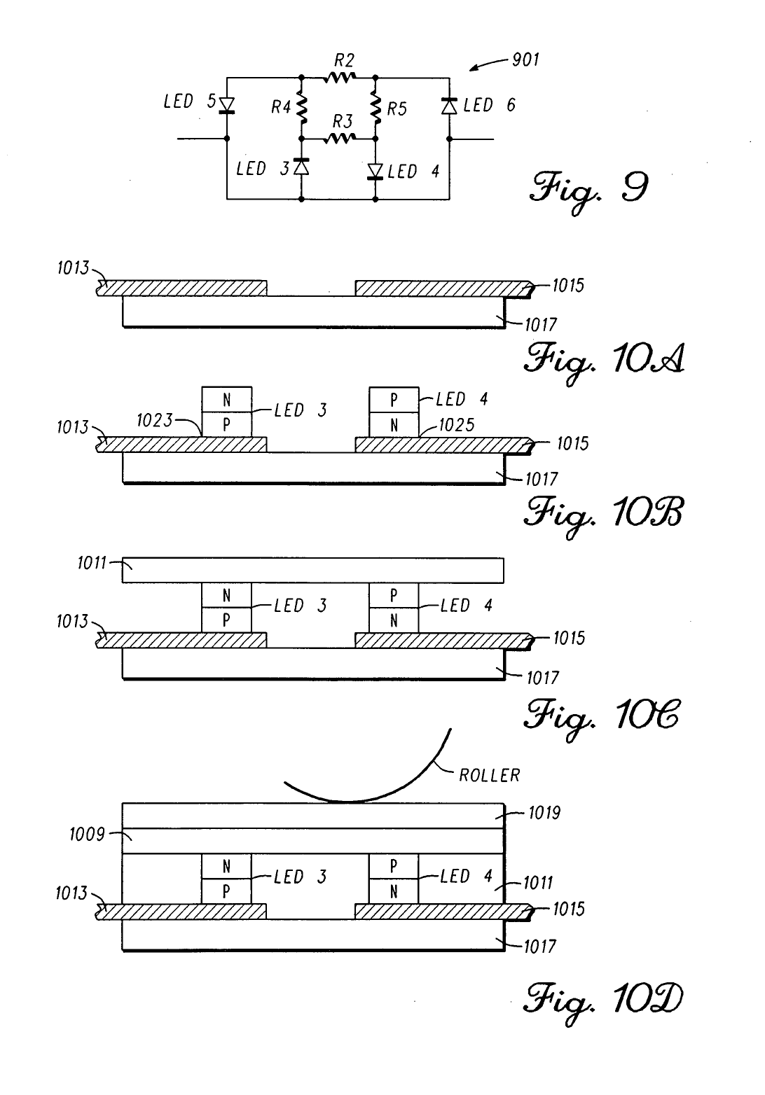

FIG. 6, FIG. 7, FIG. 8, FIG. 9, and FIG. 32, relate to LED chips disposed on a leadframe, in parallel, in a light active sheet material. FIG. 6 provides a view illustrating LED chips on the leadframe prior to lamination; FIG. 7 and FIG. 8 provide a cross-section of the LED chips in the light sheet on the leadframe; and FIG. 9 is a schematic corresponding to FIG. 7 and FIG. 8. FIG. 32 is an alternative configuration.

Referring now to FIG. 6, a perspective view of LED chips on leadframe, biased opposite of each other prior to lamination will be discussed and described. A representative leadframe 601 and LED chips 3, 4, 5, 6 are illustrated. The leadframe 601 includes tool hole edges 605, track keepers (not visible), leads 607, and LED chip placement portions (under the LED chips 3, 4, 5, 6). The tool hole edges 605 can include tool holes 603 formed therein. Generally, the discussion with respect to the leadframe 301 in connection with FIG. 3 applies to the leadframe 601 in FIG. 6. The LED chips 3, 4, 5, 6 are patterned on the leadframe.

The LED chips 3, 4, 5, 6 can be mounted on the leadframe 601. LED chips having opposite polarity which are to be electrically connected laterally across the leadframe 601 form a set of LED chips. In this illustration, a first set of LED chips includes LED chips 3, 4, and a second set of LED chips includes LED chips 5, 6.

Accordingly, in a lighting system, there can be plurality of LED chips, including the previously-discussed one or more LED chips, in the pattern of LED chip(s), and the LED chips in the pattern are electrically connected in parallel.

Referring now to FIG. 7, a cross sectional diagram of the embodiment shown in FIG. 6 taken along line VII-VII, after lamination will be discussed and described. A light active sheet material 701 includes an optional transparent substrate 707, a transparent electrically conductive top substrate (here represented by ITO layer 709), an optional bottom substrate 717, first portion 713 and second portion 715 of a leadframe, light emitting diode (LED) chips (here represented by LED 3 and LED 4), and adhesive 711.

Appropriate materials for use as the transparent top substrate 707, the transparent electrically conductive top substrate 709, the adhesive 711, the portions 713, 715 of the leadframe, and the optional bottom substrate 717, include those discussed above, for example, in connection with FIG. 1.

The transparent electrically conductive top substrate 709 is disposed below the top substrate 707, if used. The transparent electrically conductive top substrate 709 is in electrical contact with the LED chips 3, 4. As illustrated, the electrical contact between the transparent electrically conductive top substrate 709 and the LED chips 3, 4 is direct. Also, the light from the LED chips 3, 4 will be emitted through the transparent electrically conductive top substrate 709.

The LED chips 3, 4 are oriented to be driven with opposite polarity electrical energy, and are in electrical contact with the transparent electrically conductive top substrate 709. Each of the LED chips is in electrical contact with the first portion 713 or the second portion 715 of the leadframe disposed below respective LED chips 3, 4.

The adhesive 711 is disposed to fill gaps between adjacent ones of the patterned LED chips, gaps between the transparent electrically conductive top substrate 709 and the first portion 713 and the second portion 715 of the leadframe, gaps between the first portion 713 and the second portion 715 of the leadframe, and gaps between the transparent electrically conductive top substrate 709 and the optional bottom substrate 713 (if used). An adhesive such as those discussed above is appropriate.

The portions of the leadframe 713, 715 below the LED chips 3, 4 which are biased opposite of each other and connected in parallel, are spaced apart from each other so that a gap is formed between the portions of the leadframe 713, 715. The portions of the leadframe 713, 715 have opposite polarity. A resistor is formed in the transparent electrically conductive top substrate 709 between the two LED chips 3, 4.

Additional LED chips can be added and connected in parallel using the above principles, as will be appreciated by one of ordinary skill in the art.

Referring now to FIG. 8, a cross sectional diagram of the embodiment shown in FIG. 6 taken along line VIII-VIII, after lamination will be discussed and described. A light active sheet material 801 includes a transparent substrate 807, a transparent electrically conductive top substrate (here represented by ITO layer 809), an optional bottom substrate 817, first portion 813 and second portion 815 of a leadframe, light emitting diode (LED) chips (here represented by LED 5 and LED 6), and adhesive 811. The discussion with regard to FIG. 7 applies to FIG. 8, and will not be repeated here for brevity.

Reference is now made to both FIG. 7 and FIG. 8. The transparent electrically conductive top substrate 809 in FIG. 8 is the same transparent electrically conductive top substrate 709 illustrated in FIG. 7. The first portion of the leadframe 713 in FIG. 7 can be connected to a same power input as the first portion of the leadframe 813 in FIG. 8. Likewise, the second portion of the leadframe 715 in FIG. 7 can be connected to a same power input as the second portion of the leadframe 815 in FIG. 8. Adjacent LED chips 3, 5 on the first portions 713, 813 of the leadframe are oriented with opposite polarity. Similarly, adjacent LED chips 4, 6 on the second portions 715, 815 of the leadframe are oriented with opposite polarity.

Additional LED chips can be daisy-chained using the above principles.

Referring now to FIG. 9, a schematic diagram corresponding to FIG. 6 will be discussed and described. The light active sheet material 901 on the leadframe includes LED chips 3, 4, 5, 6. In a first set of LED chips, the LED chips 3, 4 are biased opposite of each other and connected in parallel (via the transparent electrically conductive top substrate 709 discussed in connection with FIG. 7), through a resistor R3. Similarly, in a second set of LED chips, the LED chips 5, 6 are biased opposite of each other and connected in parallel (via the transparent electrically conductive top substrate 809 discussed in connection with FIG. 8), through a resistor R2. Furthermore, the first set and second set of LED chips 3, 4, 5, 6 are connected in parallel via the transparent electrically conductive top substrate, through first resistor R4 and second resistor R5.

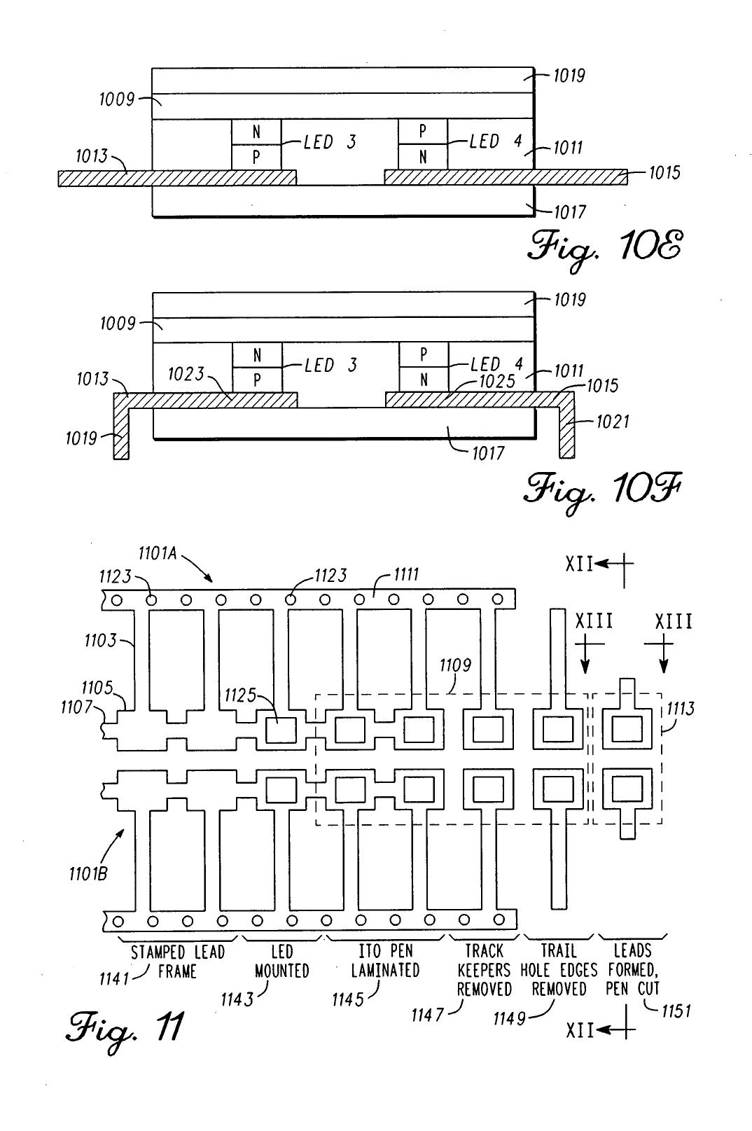

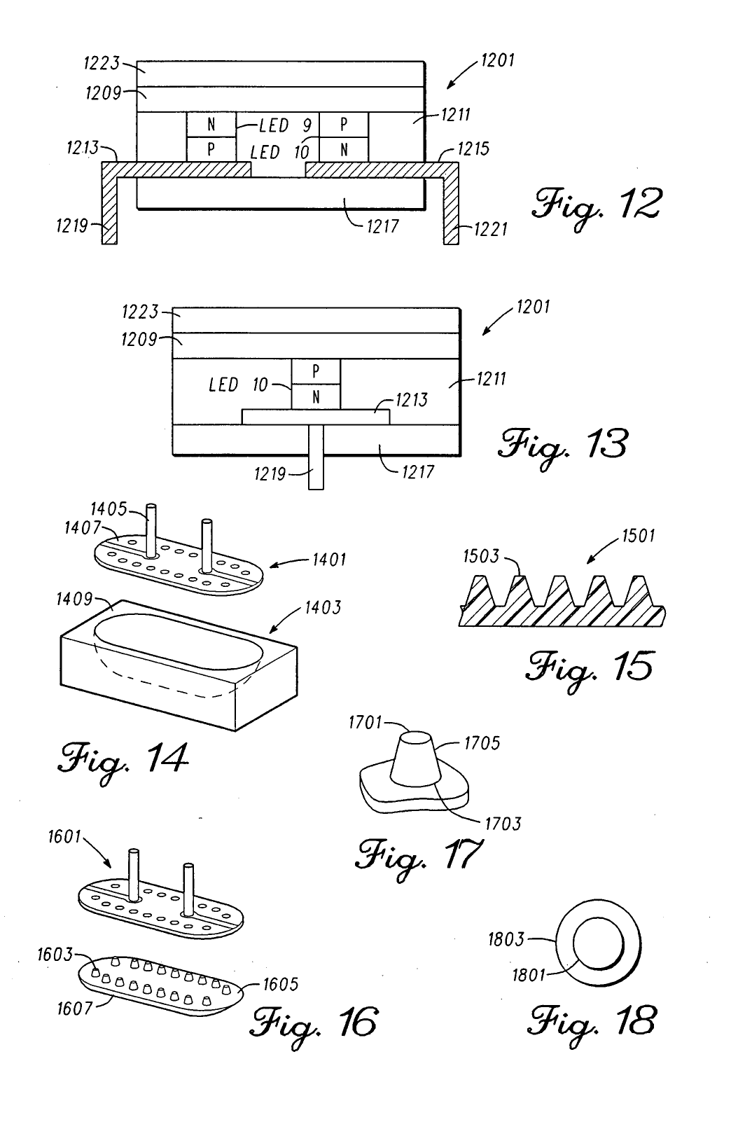

FIG. 10A to FIG. 10F, FIG. 1, FIG. 12, and FIG. 13 relate to a method of producing lightsheet on a leadframe. FIG. 10A to FIG. 10F illustrate an application of various layers according to the method; FIG. 11 summarizes the method. FIG. 12 and FIG. 13 provide side and front cross sectional views of a device produced by the method of FIG. 11.

Referring now to FIG. 10A to FIG. 10F, cross sectional diagrams illustrating a method of producing the light sheet on a leadframe will be discussed and described. In FIG. 10A, first and second portions 1013, 1015 of the leadframe are disposed on a bottom substrate 1017. The bottom substrate 1017 is optional and can be omitted, or can be applied at a later step. Optionally, the first and second portions 1013, 1015 can be mechanically connected laterally to each other, and/or parallel to an axis of the leadframe to each other, via track keepers which can later be removed. The first and second portions 1013, 1015 of the leadframe correspond to the first and second portions discussed in connection with FIG. 7.

As illustrated in FIG. 10B, the LED chips 3, 4 are patterned on chip supporting portions 1023, 1025 (sometimes referred to as “die pads”) of respective first and second portions 1013, 1015 in a predetermined pattern. The predetermined pattern can correspond to a particular shape and/or color of lamp or lighting system for which the light sheet is to be used. The LED chips 3, 4 correspond to the LED chips discussed in connection with FIG. 7.

In FIG. 10C, a non-conductive adhesive 1011 is disposed on the LED chips 3, 4. For example, the adhesive 1011 can be provided as a film over the LED chips 3, 4. The adhesive 1011 corresponds to the adhesive 711 discussed in connection with FIG. 7.

As illustrated in FIG. 10D, a transparent substrate 1019 with an ITO layer 1009 underneath is disposed (for example, by sputtering) over the adhesive 1011 and the LED chips 3, 4. A roller presses together the ITO layer 1009, the adhesive layer 1011, the LED chips 3, 4, the first and second portions of the leadframe 1013, 1015, and the optional bottom substrate 1017. By use of pressure and/or heat, the LED chips 3, 4 can be sandwiched between the first and second portions of the leadframe 1013, 1015 and ITO layer 1009 so as to be in electrical contact. Consequently, the non-conductive adhesive 1011 becomes distributed in the gaps between the first and second portions of the leadframe 1013, 1015, gaps between the bottom substrate 1017 and the ITO layer 1009, gaps between the ITO layer 1009 and the first and second portions of the leadframe 1013, 1015, and gaps between the LED chips 3, 4.

As shown in FIG. 10E, the first and second portions of the leadframe 1013, 1015 are trimmed to a desired length. For example, the trimming can eliminate track keepers and/or trail hole edges (not illustrated in this figure), so that leads of the leadframe remain extending from the supporting portions 1023, 1025 to an outside of the adhesive 1011. The leads can then be electrically connected to a power source.

Accordingly, the leadframe can include a lead extending from a portion of the leadframe below the LED chip(s), the lead exiting the light active sheet material to be connected outside the light active sheet material. For example, the lead can be connected to a lighting harness generally included with a conveyance, or to an other power source.

FIG. 10F illustrates an optional method of bending the leads to create bent portions 1019, 1021. In this illustration, the leads are bent at a 90° angle. This can permit mounting, if desired, for example on a printed circuit board (PCB) (not illustrated).

Accordingly, the lead can have a right-angle bend after the lead exits the light active sheet material.

Therefore, a method of manufacturing a lighting system can include providing a leadframe, the leadframe comprising leads and light emitting diode (LED) chip placement portions; placing a pattern of LED chips on an LED chip placement portion of the leadframe; disposing an adhesive on the leadframe and the LED chips, the adhesive being formed of a non-conductive transparent adhesive material; and after disposing the adhesive, laminating a transparent electrically conductive top substrate on the adhesive and the LED chips. The LED chips can be preformed before being patterned as an unpackaged discrete semiconductor device having an anode p-junction side and a cathode n-junction side. Either of the anode and the cathode side is in electrical communication with the top substrate and the other of the anode and the cathode side is in electrical communication with the leadframe.

The method further can include laminating a bottom substrate to the leadframe on a side opposite to the LED chips. The adhesive can be disposed on the leadframe on a side of the leadframe opposite to the bottom substrate, and the top substrate can be laminated on the adhesive and the LED chips on a side of the leadframe opposite to the bottom substrate.

Referring now to FIG. 1, a plan view illustrating a method of producing a light sheet on a leadframe will be discussed and described. A first part 1101A of a leadframe and a second part 1101B of a leadframe are provided. Also illustrated are LED chips 1125, laminated layers 1109 (including, for example, the transparent electrically conductive top substrate, adhesive layer, optional bottom substrate, and optional transparent top substrate) (outlined by a broken line), and lighting system 1113 with light active sheet material (outlined by a broken line) and integrated leadframe.

The illustrated stamped leadframe is representative of leadframes, which can take a variety of forms. The first part 1101A of the leadframe includes tool hole edges 1111, track keepers 1107, leads 1103, and LED chip placement portions 1105 (also called die pads). The tool hole edges 1111 can include tool holes 1123 formed therein. The second part 1101B of the leadframe has a similar form.

In overview, the method includes providing 1141 a stamped leadframe, mounting 1143 LED chips on the stamped leadframe, laminating 1145 the leadframe and LED chips with the desired layers for the light active sheet material such as ITO PEN, removing 1147 the track keepers from the leadframe, removing 1149 the trail hole edges from the leadframe, and forming 1151 the leads and cutting the layers to form the lighting system 1113. These steps are discussed in more detail below.

The leadframe comprising the first and second parts 1101A, 1101B is provided. The leadframe can be driven in a manufacturing process via the tool holes 1123. The LED chips 1125 are mounted on (that is, adhered to and deposited on) the die pads 1105.

The leadframe with the LED chips mounted on the die pads is laminated 1145 with the desired layers 1109 to form the light active sheet material. Such layers 1109 include, for example, ITO PEN or other transparent electrically conductive layer, optional top transparent layer, optional bottom layer, and adhesive layer.

When the layers 1109 have been formed, the track keepers can be removed 1147 from the leadframe. Also, the trail hole edges can be removed 1149 from the leadframe, so that the leads 1103 extending from the layers of the light active sheet material 1109 are no longer attached to the trail hole edges 1123.

The lighting system 1113 can be formed 1151, including forming the leads to a desired shape (such as by bending) and cutting the layers 1109 of the light active sheet material to form the lighting system 1113.

Accordingly, the leadframe can further include track keepers and tool hole edges; the method can further include removing the track keepers and tool hole edges from the leadframe, after laminating the top substrate.

Referring now to FIG. 12 and FIG. 13, a cross sectional diagram of the embodiment shown in FIG. 11 taken along lines XII-XII and lines XIII-XIII, respectively will be discussed and described. The same reference numbers are used for the same elements in FIG. 12 and FIG. 13. In cross section, a lighting system 1201 includes a transparent top substrate 1223, a top ITO layer 1209 (representing a first electrically conductive transparent layer), LED chips 9, 10, an adhesive layer 1211, bottom layer 1217 (here represented by a second electrically conductive transparent layer), first and second leads 1213, 1215, and first and second bent portions 1219, 1221 of the first and second leads 1213, 1215.

Accordingly, the method can further include forming a right-angle bend in the leads.

Although the lighting system 1201 is illustrated as including a set of two LED chips, it will be appreciated that the lighting system 1201 can be constructed to include multiple sets of LED chips, and more than two LED chips can be used in a set, using the above-discussed principles.

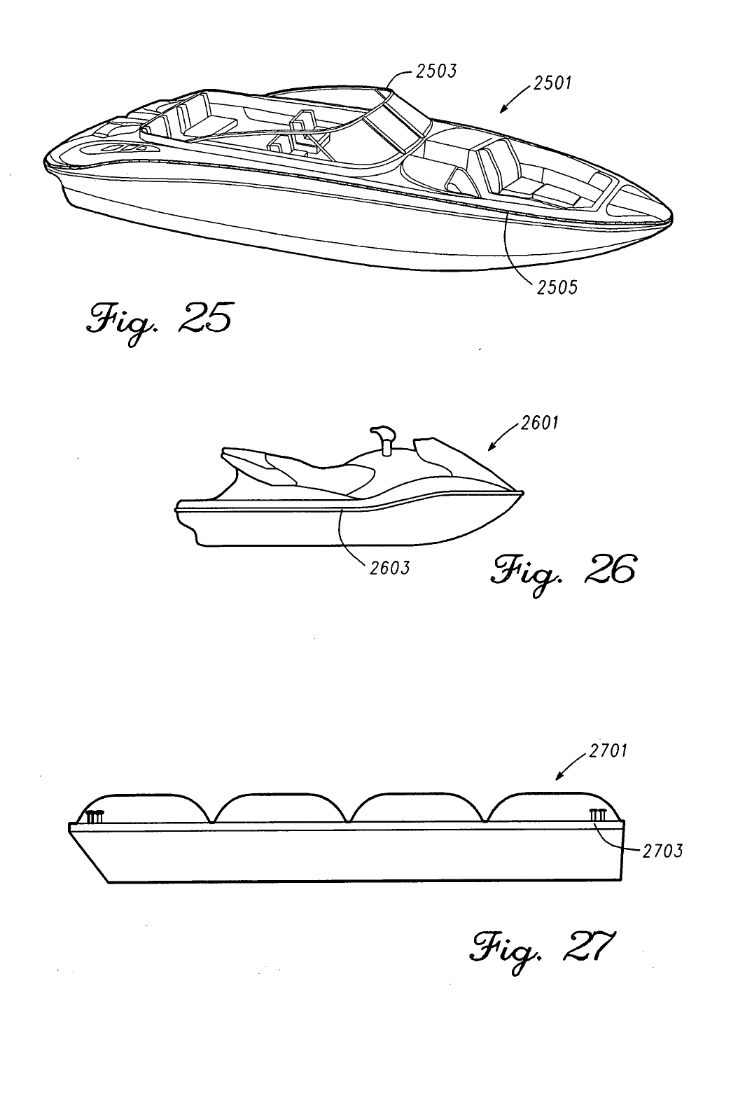

Various applications of lamps and/or lighting systems incorporating the light active sheet material with integrated leadframe are discussed in FIG. 14 to FIG. 19 and FIG. 21 to FIG. 31. FIG. 14 to FIG. 19 illustrate various lamps, FIG. 21 to FIG. 24 illustrate PC lighting systems and PC lamps with light active sheet, FIG. 25 to FIG. 30 illustrate lighting systems for various conveyances, and FIG. 31 illustrates a lamp installed on a printed circuit board (PCB). Any of the light active sheet materials discussed in FIG. 1 to FIG. 13, and similar devices appropriately arranged, can be used in the lamps and/or lighting systems discussed below.

Referring now to FIG. 14, a perspective exploded view of a lamp using a light sheet on a leadframe will be discussed and described. A lighting system can be prepared with a mold 1403 and a lighting unit 1401.

The lighting unit 1401 includes a light sheet 1407 with terminals 1405. The light sheet 1407 has a leadframe integrated therein, as described above. The terminals 1405 can be attached to the leads extending from the light sheet 1407.

The light sheet 1407 is stamped or cut to the desired dimensions, for example so that its perimeter is the same as the perimeter of the desired lens. A clear or color transmissive epoxy can be provided in the interior of the mold 1403. The light sheet 1407 can be placed in the mold 1403 with epoxy in the mold. The terminals 1405 can be attached to the leads from the light sheet prior to or after the light sheet 1407 is placed in the mold 1403. The mold 1403 with the epoxy and the light sheet 1407 can be UV cured. If the mold 1403 is clear, then UV can penetrate from all angles. Optionally, the light sheet with epoxy then can be removed from the mold, whereby the UV hardened epoxy forms a lens. Alternatively, a desired lens can be used as the mold 1403 and can remain attached to the cured epoxy and the light sheet 1407.

Accordingly, there can be provided a lighting system which further includes a lens, the lens having a predetermined dimension, the leadframe with the light active sheet material being disposed on the lens.

Referring now to FIG. 15, a cross sectional diagram of a lens with conical optics for a lamp using a light sheet will be discussed and described. The lens of the lighting system illustrated in FIG. 14 alternatively can incorporate optics. Cones, facets, or any form of optics can be incorporated into the mold, and therefore can be cast into the lighting system. In this illustration, the lens 1501 incorporates cones 1503. The cones 1503 can be positioned to correspond to LED chips in the light sheet. Accordingly, an optical cone 1503 can be cast at each LED chip. Optionally, a second casting can be performed to fill in the cones 1503 and to create a smooth outer lens.

Referring now to FIG. 16, a lamp with conical optics using a light sheet on a leadframe will be discussed and described. The lamp includes a light sheet 1601 with attached terminals, for example as discussed in FIG. 14, and a lens 1605. The lens 1605 can include optics, for example cones 1603, and a smooth outer lens 1607. The lens 1605 can be formed of plastic or other conventional lens material.

A clear or color transmissive epoxy can be provided in the interior of the lens 1605. The light sheet 1601 with attached terminals can be placed in the lens 1605. The lens 1605 with the epoxy and the light sheet 1601 can be UV cured. Optionally, the lens 1605 can remain permanently affixed via the epoxy to the light sheet 1601, as part of the lamp.

Accordingly, a method of manufacturing a lighting device can include providing a lighting system, wherein the lighting system includes a leadframe, and a light active sheet material laminated on the leadframe and electrically connected to the leadframe. The light active sheet material can include a transparent electrically conductive top substrate, and a pattern of light emitting diode (LED) chips sandwiched between the leadframe and the top substrate, wherein the LED chips are preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the leadframe, and wherein a non-conductive transparent adhesive material is disposed between the leadframe, the LED chips, and the top substrate. The method also can include providing a mold having a predetermined dimension, forming the lighting system to the predetermined dimension, placing the formed lighting system in the mold, filling the mold with a polymer, and curing the polymer in the mold, to form a lighting device.

Further, the leadframe can include a lead extending from a portion of the leadframe below the LED chips, the lead exiting the light active sheet material to be connected outside the light active sheet material. Moreover, the mold can be optically formed.

Referring now to FIG. 17, a perspective view of a cone for a lens with conical optics will be discussed and described. The optics used for the lamp mold and/or the lamp lens can include one or more cones 1705. Such a cone includes a bottom radius 1703 which is larger than a top radius 1701.

Referring now to FIG. 18, a top view of the cone for the lens with conical optics will be discussed and described. Here, a bottom radius 1081 of the cone is shown to be larger than a top radius 1803.

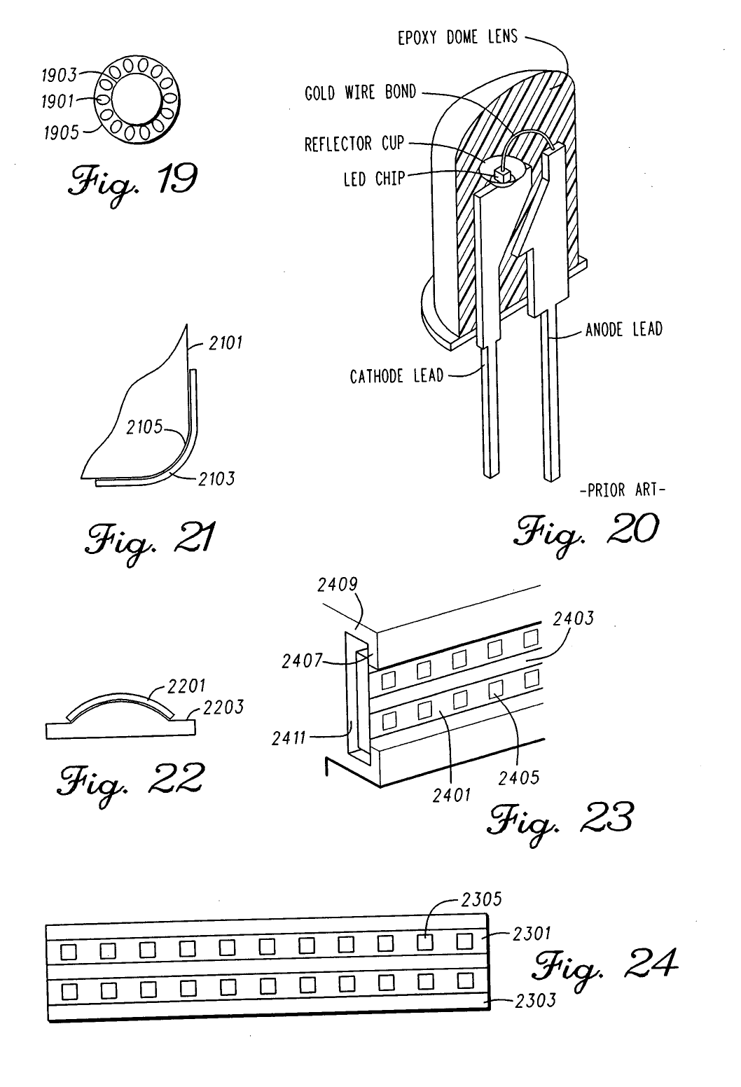

Referring now to FIG. 19, a top view of a faceted optic for a lens with conical optics will be discussed and described. The faceted optic is generally cone-shaped and includes a bottom radius 1905 which is larger than the top radius 1903. The faceted optic also includes facets 1901 distributed between the bottom and top radii 1903, 1905.

Accordingly, the lighting system can further include a lens, the leadframe with the light active sheet material being disposed on the lens, the lens having a cone or facet formed thereon and positioned to correspond to a light path from the LED chip(s).

FIG. 21 to FIG. 24 illustrate PC lighting systems and PC lamps with light active sheet. Referring now to FIG. 21, a plan view of a light sheet on a leadframe mounted on trailer corner will be discussed and described. Here, the light sheet with integrated leadframe 2103 (as described above) can be attached around a front corner 2105 of a trailer or other conveyance 2101.

The light sheet 2103 can be trimmed to a desired length, with a desired number of LED chips. The leadframe in the light sheet 2103 can be bent to the desired shape to fit on the corner 2105. Further, it is not necessary to reshape the corner 2105 to fit the light sheet 2103.

The light sheet 2105 can be attached, via the leads of the leadframe, to an electrical wiring harness of the trailer, or other conventional power source. This lamp can pass the relevant PC ratings tests.

Accordingly, the leadframe and light active sheet material laminated thereon can be formed to be attached around a front corner of a trailer or other conveyance.

Referring now to FIG. 22, a cross sectional view of a light sheet on a leadframe attached to radii lamp base will be discussed and described. Here, the light sheet with integrated leadframe 2201 (as described above) can be attached around a lamp 2203 with radii lamp base.

The light sheet 2201 can be trimmed to a desired length, with a desired number of LED chips. The leadframe in the light sheet 2201 can be bent to the desired shape to fit over the curved base of the lamp 2203.

The light sheet 2201 can be attached, via the leads of the leadframe, to an electrical wiring harness of the conveyance on which the lamp is used, or other conventional power source. This lamp also can pass the relevant PC ratings tests.

Accordingly, the leadframe and light active sheet material laminated thereon can be attached to a radii lamp base.

FIG. 23 and FIG. 24 provide views of a marker lamp. Referring now to FIG. 23, a plan view of a marker lamp integrated with a leadframe will be discussed and described. The marker lamp includes a light active sheet material 2303 with integrated leadframe 2301 and integrated LED chips 2305, as described above. The axially linear halves of the leadframe 2301 have opposite polarity. Advantageously, the leadframe can be copper. The LED chips allow lighting along the entire marker lamp, or can permit lighting only at specified locations.

Referring now to FIG. 24, a perspective view of the marker lamp of FIG. 23 mounted on a trailer will be discussed and described. In this view, a trailer is provided with a slot 2411, for example as a top rail or a back rail. The slot includes legs 2409 and clamping portions 2407, together forming a frame sized to hold a marker lamp therein. The marker lamp includes a light sheet 2403, a leadframe 2401 incorporated into the light sheet, and LED chips 2405 integrated into the light sheet.

In this illustration, the frame is formed from the trailer. Alternatively, the frame can be mounted on the trailer. The marker lamp can be used not only on the trailer, but also on other conveyances, as well.

The marker lamp can be attached, via the leads (not illustrated) of the leadframe 2401, to an electrical wiring harness of the conveyance on which the marker lamp is used, or other conventional power source.

Accordingly, the leadframe can have a linear form, such that there are a plural sets of LED chips. Each set of LED chips can include at least two LED chips biased opposite of each other and electrically connected in parallel laterally across the leadframe. The sets of LED chips can be distributed axially along the leadframe.

Furthermore, the leadframe and light active sheet material laminated thereon can be formed to be attached to a frame disposed on a conveyance.

Accordingly, a method of providing a conveyance with a lighting system can include providing a lighting system, wherein the lighting system includes a leadframe, and a light active sheet material laminated on the leadframe and electrically connected to the leadframe, wherein the light active sheet material comprises a transparent electrically conductive top substrate, and a pattern of light emitting diode (LED) chips sandwiched between the leadframe and the top substrate, wherein the LED chips are preformed before being patterned in the light active sheet material as an unpackaged discrete semiconductor device having an anode p-junction side and a cathode n-junction side, wherein either of the anode and the cathode side is in electrical communication with the top substrate and the other of the anode and the cathode side is in electrical communication with the leadframe, wherein a non-conductive transparent adhesive material disposed between the leadframe, the LED chips, and the top substrate; mounting the lighting system on the conveyance; and electrically connecting the lighting system to an electrical wiring harness of the conveyance.

The lighting system can be formed to be attached to a frame disposed on the conveyance, or a body panel of the conveyance. The mounting further can include attaching the lighting system to the frame or body panel. Attaching such a thin and flexible lighting system to a conveyance can reduce the tooling and manufacturing cost.

FIG. 25 to FIG. 30 illustrate various configurations of lighting systems for various conveyances. In FIG. 25 to FIG. 29, the conveyances are watercraft. Watercraft can be made more visible at night by using light sheet with integrated leadframe as an illuminated tape above the water line to give a good indication of the dimensions of the watercraft.

Referring now to FIG. 25, a side view of a first watercraft illuminated with a light sheet leadframe tape will be discussed and described. The light sheet with integrated leadframe (described herein above) can be elongated, conveniently referred to as “tape.” The watercraft 2501 is illuminated with a canopy tape 2503 on the top of the canopy of the watercraft 2501, and a bow tape 2505 along the top of the bow.

Referring now to FIG. 26, a side view of a second watercraft illuminated with the light sheet leadframe tape will be discussed and described. An illuminated tape 2603 is provided from bow to stem of a smaller watercraft 2601.

Referring now to FIG. 27, a side view of a barge illuminated with the light sheet leadframe tape will be discussed and described. Here, an illuminated tape 2703 is provided to outline the top of a hull, from bow to stem of a barge 2701.

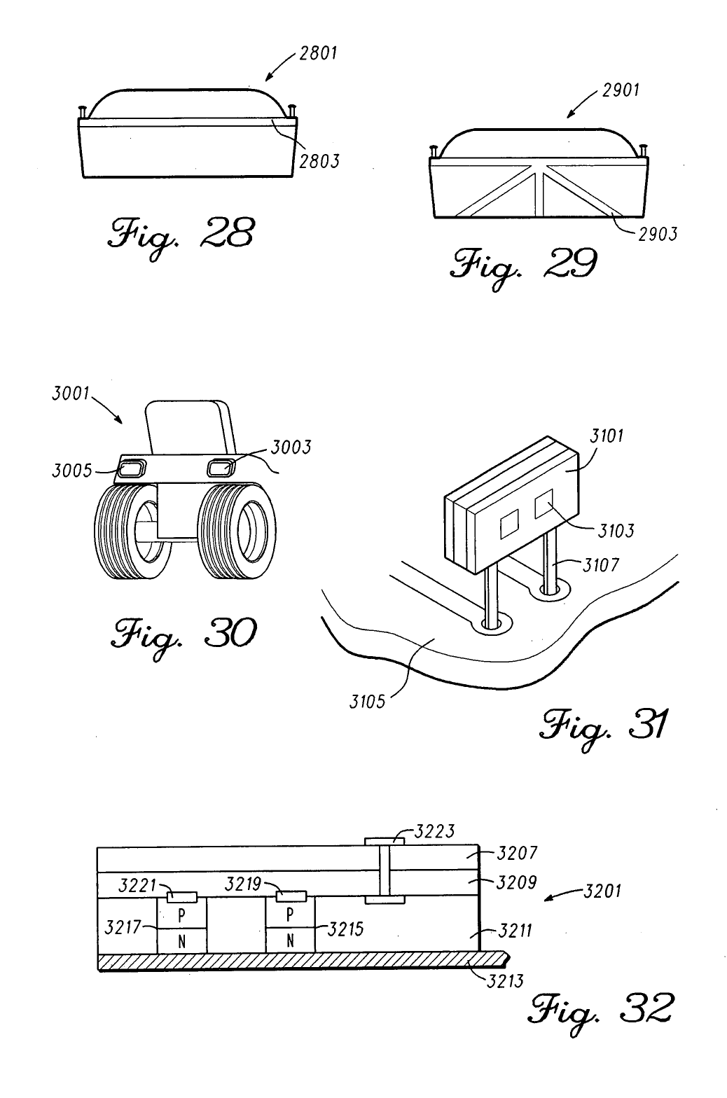

Referring now to FIG. 28, a rear view of a watercraft illuminated with the light sheet leadframe tape will be discussed and described. Here, an illuminated tape 2803 is provided to outline the top of a stern of a watercract 2801.

Referring now to FIG. 29, a rear view of the watercraft illuminated with an alternative configuration of the light sheet leadframe tape will be discussed and described. An illuminated tape 2903 is provided to outline the top of a stern of a barge 2901.

Referring now to FIG. 30, a perspective view of a lawn mower with a surface mounted light sheet leadframe lamp will be discussed and described. A riding lawimower 3001 uses light sheet leadframe lamps 3003, 3005 instead of conventional tail lamps. In addition, most lawnmowers conventionally do not include any forward lighting. A light sheet leadframe tape or light sheet leadframe lighting system can be disposed across the front of the lawn mower 3001 to provide forward lighting.

Light sheet leadframe tape or light sheet leadframe lighting systems also can be provided on other conveyances using the principles discussed above.

Accordingly, in a lighting system, the leadframe and light active sheet material laminated thereon can be formed as a lighting system for a conveyance, wherein the at least one LED chip has red or white or amber or blue or green colors, and wherein the color of the at least one LED chip in the pattern are disposed in a pattern as a head light system, a rear lighting system, or side marker lamp system.

Referring now to FIG. 31, a perspective view of a light sheet leadframe package mounted on a printed circuit board (PCB) will be discussed and described. A light sheet 3101 with integrated leadframe is provided. The light sheet has integrated LED chips, here represented by two LED chips 3103. Leads 3107 extend from the light sheet 3101. In this example, the leads 3107 include a 90° bend. The leads 3107 can be soldered or affixed to a PCB 3105.

Referring now to FIG. 32, a cross sectional diagram illustrating LEDs on a leadframe, connected in parallel will be discussed and described. A light active sheet material 3201 includes a transparent substrate 3207, a transparent electrically conductive top substrate (here represented by ITO layer 3209), a leadframe 3213, light emitting diode (LED) chips (here represented by LED 3215 and LED 3217), adhesive 3211, contacts 3219, 3221, and a conductive trace 3223.

Appropriate materials for use as the transparent top substrate 3207, the transparent electrically conductive top substrate 3209, the adhesive 3211, and the leadframe 3213, include those discussed above, for example, in connection with FIG. 1.

The transparent electrically conductive top substrate 3209 is disposed below the transparent substrate 3207, if used. The transparent electrically conductive top substrate 3209 is in electrical contact with the LED chips 3215, 3217. As illustrated, the electrical contact between the transparent electrically conductive top substrate 3209 and the LED chips 3215, 3217 is direct. Also, the light from the LED chips 3215, 3217 will shine through the transparent electrically conductive top substrate 3209.

The LED chips 3215, 3217 are oriented to be driven with the same polarity electrical energy, and are in electrical contact with the transparent electrically conductive top substrate 3209. Each LED chip 3215, 3217 is in electrical contact with the leadframe 3213. The leadframe 3213 has a polarity opposite to the polarity of the transparent electrically conductive top substrate 3209; as illustrated, the leadframe 3213 can have a negative polarity and the transparent top substrate 3207 can have a positive polarity.

The adhesive 3211 is disposed to fill gaps between the patterned LED chips 3215, 3217, and gaps between the transparent electrically conductive top substrate 3209 and the leadframe 3213.

Each of the LED chips 3215, 3217 include a contact 3219, 3221 disposed between each of the LED chips and the ITO layer 3209. The contact 3219, 3221 is made of an electrically conductive material, for example, gold. Also illustrated is a conductive trace 3223 in the transparent electrically conductive top substrate 3209 and the transparent substrate 3207.

Additional LED chips can be added and connected in parallel using the above principles, as will be appreciated by one of ordinary skill in the art.

It should be noted that the term conveyance is used herein to indicate something which serves as a means of transportation. Examples of conveyances, as the term is used herein, include automobiles, trucks, buses, other motorized land vehicles such as ride-on lawn mowers, trains, aircraft, watercraft, heavy machinery used for regulated or non-regulated industries such as agricultural, lawn care, mining, snow blowing, trailers for use with the foregoing, and the like, and variants or evolutions thereof.

An LED chip utilized with the light active material can be organic (OLED) or inorganic (ILED), although testing shows that ILED chips are particularly preferable. Appropriate OLED and ILED chips are readily available from many manufacturers. The LED chips can be clear, red, white, amber, blue, or green colors. Combinations of colored LED chips can be used.

A leadframe, sometimes called a “lead frame,” provides mechanical support to a semiconductor chip during its assembly into a finished product. A typical leadframe is a roll of thin metal sheet material which is stamped and formed, and then rolled again into a roll. The features stamped into the sheet so that a semiconductor component can be attached and electricity routed to the semiconductor component. Various appropriate leadframes are readily available commercially.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A lighting system, comprising:
a leadframe; and
a light active sheet material laminated on the leadframe and electrically connected to the leadframe,
wherein the light active sheet material comprises a transparent electrically conductive top substrate, a pattern of at least one light emitting diode (LED) chip sandwiched between the leadframe and the top substrate, and a non-conductive transparent adhesive material disposed between the leadframe, the at least one LED chip, and the top substrate,
wherein the at least one LED chip is preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the leadframe.

2. The lighting system of claim 1, wherein there are a plurality of LED chips, including the at least one LED chip, in the pattern, and the LED chips in the pattern are electrically connected in parallel.

3. The lighting system of claim 1, wherein there are a plurality of LED chips, including the at least one LED chip, in the pattern, and the LED chips in the pattern are electrically connected in series, wherein adjacent connected LED chips are biased opposite of each other.

4. The lighting system of claim 1, wherein there are a plurality of LED chips including the at least one LED chip, wherein a first portion of the leadframe below and in electrical communication with one of the LED chips is spaced apart from a second portion of the leadframe below and in electrical communication with the other of the LED chips which are electrically connected.

5. The lighting system of claim 1,
wherein the leadframe has a linear form,
wherein there are a plurality of sets of LED chips including the at least one LED chip,
wherein each set of LED chips includes at least two LED chips biased opposite of each other and electrically connected laterally across the leadframe,
wherein the sets of LED chips are distributed axially along the leadframe.

6. The lighting system of claim 1, further comprising a bottom substrate disposed on the leadframe on a side opposite to the at least one LED chip.

7. The lighting system of claim 1, further comprising a lens, the lens having a predetermined dimension, the leadframe with the light active sheet material being disposed on the lens.

8. The lighting system of claim 1, further comprising a lens, the leadframe with the light active sheet material being disposed on the lens, the lens having a cone or facet formed thereon and positioned to correspond to a light path from the at least one LED chip.

9. The lighting system of claim 1, wherein the leadframe includes a lead extending from a portion of the leadframe below the at least one LED chip, the lead exiting the light active sheet material to be connected outside the light active sheet material.

10. The lighting system of claim 9, wherein the lead has a right-angle bend after the lead exits the light active sheet material.

11. The lighting system of claim 1, wherein the leadframe and light active sheet material laminated thereon are formed to be attached around a front corner of a conveyance.

12. The lighting system of claim 1, wherein the leadframe and light active sheet material laminated thereon are attached to a radii lamp base.

13. The lighting system of claim 1, wherein the leadframe and light active sheet material laminated thereon are formed to be attached to a frame or a body panel disposed on a conveyance.

14. The lighting system of claim 1,
wherein the leadframe and light active sheet material laminated thereon are formed as a lighting system for a conveyance,
wherein the at least one LED chip has red or white or amber or blue or green colors, and
wherein the color of the at least one LED chip in the pattern are disposed in a pattern as a head light system, a rear lighting system, or side marker lamp system.

15. A method of manufacturing a lighting system, comprising:
providing a leadframe, the leadframe comprising leads and light emitting diode (LED) chip placement portions;
placing a pattern of LED chips on an LED chip placement portion of the leadframe;
disposing an adhesive on the leadframe and the LED chips, the adhesive being formed of a non-conductive transparent adhesive material; and
after disposing the adhesive, laminating a transparent electrically conductive top substrate on the adhesive and the LED chips,
wherein the LED chips are preformed before being patterned as an unpackaged discrete semiconductor device having an anode p-junction side and a cathode n-junction side,
wherein either of the anode and the cathode side is in electrical communication with the top substrate and the other of the anode and the cathode side is in electrical communication with the leadframe.

16. The method of claim 15, further comprising laminating a bottom substrate to the leadframe on a side opposite to the LED chips,
wherein the adhesive is disposed on the leadframe on a side of the leadframe opposite to the bottom substrate,
wherein the top substrate is laminated on the adhesive and the LED chips on a side of the leadframe opposite to the bottom substrate.

17. The method of claim 15, wherein the leadframe further includes track keepers and tool hole edges, the method further comprising removing the track keepers and tool hole edges from the leadframe, after laminating the top substrate.

18. The method of claim 15, further comprising forming a right-angle bend in the leads.

19. The method of claim 15, wherein the pattern includes at least two LED chips electrically connected in parallel.

20. The method of claim 17, wherein a first portion of the leadframe below and in electrical communication with one of the LED chips is spaced apart from a second portion of the leadframe below and in electrical communication with the other of the at least two LED chips which are electrically connected in parallel.

21. The method of claim 15,
wherein the leadframe has a linear form,
wherein there are a plurality of sets of LED chips,
wherein each set of LED chips includes at least two LED chips biased opposite of each other and electrically connected in parallel laterally across the leadframe,
wherein the sets of LED chips are distributed axially along the leadframe.

22. The method of claim 15, further comprising disposing the leadframe with the laminated top substrate further on a lens, the lens having a predetermined dimension.

23. The method of claim 15, further comprising disposing the leadframe with the laminated top substrate on a lens, the lens having a cone or facet formed thereon and positioned to correspond to a light path from each of the LED chips.

24. The method of claim 15, wherein the lead exits the adhesive to be connected outside the adhesive, further comprising forming a right-angle bend in the lead outside the adhesive.

25. The method of claim 15, further comprising forming the leadframe to be attached around a front corner of a conveyance.

26. A method of providing a conveyance with a lighting system, comprising:
providing a lighting system, wherein the lighting system includes a leadframe, and a light active sheet material laminated on the leadframe and electrically connected to the leadframe,
wherein the light active sheet material comprises a transparent electrically conductive top substrate, and a pattern of light emitting diode (LED) chips sandwiched between the leadframe and the top substrate,
wherein the LED chips are preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the leadframe,
wherein a non-conductive transparent adhesive material disposed between the leadframe, the LED chips, and the top substrate,
mounting the lighting system on the conveyance; and
electrically connecting the lighting system to an electrical wiring harness of the conveyance.

27. The method of claim 26, wherein the lighting system is formed to be attached to a frame disposed on the conveyance, wherein the mounting further includes attaching the lighting system to the frame.

28. A method of manufacturing a lighting device, comprising:
providing a lighting system, wherein the lighting system includes a leadframe, and a light active sheet material laminated on the leadframe and electrically connected to the leadframe,
wherein the light active sheet material comprises a transparent electrically conductive top substrate, and a pattern of light emitting diode (LED) chips sandwiched between the leadframe and the top substrate,
wherein the LED chips are preformed before being patterned in the light active sheet material as an unpackaged discrete semiconductor device having an anode p-junction side and a cathode n-junction side,
wherein either of the anode and the cathode side is in electrical communication with the top substrate and the other of the anode and the cathode side is in electrical communication with the leadframe, and
wherein a non-conductive transparent adhesive material is disposed between the leadframe, the LED chips, and the top substrate;
providing a mold having a predetermined dimension;
forming the lighting system to the predetermined dimension;
placing the formed lighting system in the mold;
filling the mold with a polymer; and
curing the polymer in the mold, to form a lighting device.

29. The method of claim 28, wherein the leadframe includes a lead extending from a portion of the leadframe below the LED chips, the lead exiting the light active sheet material to be connected outside the light active sheet material.

30. The method of claim 28, wherein the mold is optically formed.
